(19) United States
(12) Patent Application Publication
(10) Pub. No.: US 2011/0111280 A1
(43) Pub. Date: May 12, 2011

(54) LITHIUM-ION SECONDARY BATTERY

(76) Inventors: Hiromi Tamakoshi, Osaka (JP); Keisuke Kawabe, Osaka (JP); Hyo Azuma, Osaka (JP); Shinsuke Shibata, Osaka (JP)

(21) Appl. No.: 13/001,279

(22) PCT Filed: Jun. 25, 2009
(86) PCT No.: PCT/JP09/61575

§ 371 Date: Dec. 23, 2010

(30) Foreign Application Priority Data
Jun. 25, 2008 (JP) 2008-165378
Jan. 16, 2009 (JP) 2009-007138

(51) Int. Cl. H01M 2/16; H01M 2/18

(52) U.S. Cl. 429/144

(57) ABSTRACT

A lithium-ion secondary battery includes a negative electrode having a negative electrode mixture layer containing a negative electrode active material and a separator. The negative electrode active material contains a carbon material having an R value of Raman spectrum of 0.2 to 0.8 and having an interplanar spacing d₀₀₂ between 002 lattice planes of 0.340 nm or less, a ratio of the carbon material is 60 mass % or more based on the total amount of the negative electrode active material, a density of the negative electrode mixture layer is 1.40 g/cm³ to 1.65 g/cm³, and the separator is formed from a laminate composed of a porous layer containing resin having a melting point of 120° C. to 140° C., and a porous layer containing resin having a melting point of 150° C. or higher or a porous layer composed mainly of inorganic particles having a heat resistant temperature of 150° C. or higher.

### TECHNICAL FIELD

The present invention relates to a lithium-ion secondary battery used for various electrical devices.

### BACKGROUND ART

Lithium-ion secondary batteries, which are a kind of non-aqueous electrolyte batteries, have a high energy density, and thus have been used widely as a power source for portable devices such as a mobile phone and a notebook personal computer. Further, with due considerations to environmental issues, rechargeable secondary batteries are becoming more important, and they are considered for application not only to portable devices but also to automobiles, electric tools, electric chairs, and power storage systems for household and business use.

As described above, batteries are required to have wide-ranging characteristics so as to correspond to various application purposes. In the application purpose such as electric tools where batteries are expected to be used at large current, batteries are required to have higher energy density for use at high current and have shorter charging time, that is, they are required to have further improved input/output characteristics for corresponding to high-load devices.

In order to respond to such requests, the production of an electrode active material suitable for a high current load has been studied. For example, it has been proposed to produce a composite material having a non-crystalline or low-crystalline carbon coating layer on a surface of a graphite particle, from a carbon material used generally as a negative electrode active material (see Patent Documents 1 to 4).

### PRIOR ART DOCUMENT

### Patent Document

Patent Document 1: JP 06-267531 A
Patent Document 2: JP 10-162858 A
Patent Document 3: JP 2002-42887 A
Patent Document 4: JP 2003-168429 A

### SUMMARY OF INVENTION

### Problem to be Solved by the Invention

However, in the application purpose such as electric tools where both charge and discharge are performed at large current, the reaction at electrodes is less likely to be uniformized, and high heat generated during the charge/discharge tends to locally deteriorate the inside of the electrode after the repetition of use. Because of this, characteristic degradation develops further, as compared with the application purpose such as mobile phones where not so high current is required.

There also is a concern that the heat generated during the charge/discharge affects not only the electrodes but also components of the battery. Generally, in electric tools, a few electric cells are packed as a set. When the temperature inside the cells increases due to the charge/discharge, heat is held inside the pack, which further increases the temperature of the cells. As a result, the internal temperature of the electric cells is increased to the vicinity of a melting point of a separator, which gradually clogs the separator and blocks the large current charge/discharge. Therefore, batteries capable of maintaining reliability for a long period have been demanded.

### Means for Solving Problem

The present invention solves the above-described problems, and its object is to provide a lithium-ion secondary battery that has superior reliability and charge-discharge cycle life at large current and that is suitable for the application purpose such as electric tools where charge and discharge are repeated at large current.

A lithium-ion secondary battery of the present invention includes: a negative electrode having a negative electrode mixture layer containing a negative electrode active material; a positive electrode having a positive electrode mixture layer containing a positive electrode active material; a separator; and a non-aqueous electrolyte, wherein the negative electrode active material contains a carbon material having an R value of Raman spectrum of 0.2 to 0.8 when excited by an argon laser with a wavelength of 514.5 nm and having an interplanar spacing d₀₀₂ between 002 lattice planes of 0.340 nm or less, a ratio of the carbon material is 60 mass % or more based on the total amount of the negative electrode active material, a density of the negative electrode mixture layer is 1.40 g/cm³ to 1.65 g/cm³, and the separator is formed from a laminate composed of a porous layer containing resin having a melting point of 120° C. to 140° C., and a porous layer containing resin having a melting point of 150° C. or higher or a porous layer composed mainly of inorganic particles having a heat resistant temperature of 150° C. or higher.

### Effects of the Invention

According to the present invention, it is possible to provide a lithium-ion secondary battery that is less likely to cause characteristic degradation due to charge/discharge at large current, that maintains characteristics stably for a long period, and that has high reliability even under relatively high temperature environment.

### BRIEF DESCRIPTION OF DRAWING

FIG. 1 is a cross-sectional view showing an exemplary lithium-ion secondary battery of the present invention.

### DESCRIPTION OF THE INVENTION

Hereinafter, an example of a lithium-ion secondary battery according to the present invention will be described. The exemplary lithium-ion secondary battery of the present invention includes a negative electrode that has a negative electrode mixture layer containing a negative electrode active material, a positive electrode that has a positive electrode mixture layer containing a positive electrode active material, a separator, and a non-aqueous electrolyte.

The above-described negative electrode is obtained by applying a coating that contains a negative electrode active material, a conductive powder serving as a conductive assistant and a binder onto a current collector such as a copper foil, drying the coating so as to form a negative electrode mixture layer, and press-forming the layer. At this time, in order to increase the energy density of the negative electrode mixture layer, the press-forming may be performed so that the density of the layer becomes 1.40 g/cm³ or more. Meanwhile, in order to uniformize saturation of the electrolyte to the negative electrode mixture layer for the purpose of uniformizing the reaction inside the negative electrode mixture layer during charge/discharge, the density of the layer preferably is 1.65 g/cm³ or less, and more preferably is 1.60 g/cm³ or less. For example, it is possible to control the density of the negative electrode mixture layer by adjusting formation conditions of the negative electrode in the press-forming step.

As the negative electrode active material, a carbon material having an R value of Raman spectrum (a value of a ratio between Raman intensity I₁₃₅₀ in the vicinity of 1350 cm⁻¹ and Raman intensity I₁₅₈₀ in the vicinity of 1580 cm⁻¹: I₁₃₅₀/I₁₅₈₀) of 0.2 to 0.8 when excited by an argon laser with a wavelength of 514.5 nm and having an interplanar spacing d₀₀₂ between 002 lattice planes of 0.340 nm or less is used. The R value preferably is 0.3 or more and 0.5 or less. Such a carbon material has a large electric capacity and corresponds to large current charge/discharge by smooth insertion/desorption of lithium ions on particle surfaces. Further, such a carbon material suppresses the reaction with the electrolyte and thus avoids decomposition of the electrolyte due to heat generation in charge/discharge, thereby maintaining excellent characteristics for a long period even after repetition of the large current charge/discharge. Particularly, it is preferable that a BET specific surface area of the negative electrode active material is 1.5 to 4.5 m²/g for exhibiting the above-described effects smoothly. It is more preferable that the BET specific surface area of the negative electrode active material is 2.5 m²/g or more and 3.6 m²/g or less.

The BET specific surface area of the negative electrode active material as used herein refers to a specific surface area of the surface of the active material and fine pores, obtained by measuring and calculating a surface area, using a BET expression that is a theoretical expression of multilayer adsorption. Specifically, the BET specific surface area is a value obtained using a specific surface area measurement apparatus (“Macsorb HM modele-1201” manufactured by Mountech Co. Ltd.) by a nitrogen adsorption method.

The above-described carbon material may be used alone as a negative electrode active material, or may be used together with other carbon materials or other materials for increasing conductivity, capacity or the like of the negative electrode mixture layer. In this case, for causing the above-described effects of the carbon material smoothly, the ratio of the carbon material preferably is 60 mass % or more based on the total amount of the negative electrode active material.

Examples of the other carbon materials used together with the above-described carbon material include high-crystalline carbon materials having the R value of less than 0.2 and low-crystalline carbon materials having the d₀₀₂ of 0.340 nm or more. Further, examples of the materials other than the carbon materials include: elements alloyed with Li such as Si and Sn; alloys of these elements and metallic elements such as Co, Ni, Mn and Ti; oxides of the elements alloyed with Li such as SiO; and oxides having a spinel structure represented by Li₄Ti₅O₁₂ and LiMn₂O₄.

The above-described conductive assistant may be added on an as needed basis for the purpose of improving the conductivity or the like of the negative electrode mixture layer. Examples of the conductive powder serving as a conductive assistant include carbon powders such as carbon black, ketjen black, acetylene black, fibrous carbon and graphite as well as metallic powder such as nickel powder.

Examples of the above-described binder include but are not limited to cellulose-ether compounds and rubber-based binders. Specific examples of the cellulose-ether compounds include carboxymethyl cellulose, carboxyethyl cellulose, hydroxyethyl cellulose, alkali metal salts thereof including lithium, sodium, and potassium salts, and ammonium salts thereof. Specific examples of the rubber-based binders include styrene-conjugated diene copolymers such as styrene-butadiene copolymer rubber (SBR); nitrile-conjugated diene copolymer rubber such as nitrile-butadiene copolymer rubber (NBR); silicone rubber such as polyorganosiloxane; acrylic acid alkyl ester copolymer; acrylic rubber obtained by copolymerization of acrylic acid alkyl ester and ethylenically unsaturated carbonic acid and/or other ethylenically unsaturated monomer; and fluorocarbon rubber such as vinylidene fluoride copolymer rubber.

The above-described positive electrode is obtained by applying a coating that contains a positive electrode active material, a conductive powder serving as a conductive assistant and a binder onto a current collector such as an aluminum foil, drying the coating so as to form a positive electrode mixture layer, and press-forming the layer.

Although the positive electrode active material is not limited particularly, the following can be used preferably: lithium-containing complex oxides of spinel structure [e.g., lithium manganese oxides represented by the general formula LiMn₂O₄ (including complex oxides in which a part of the constituent elements is substituted by an element such as Co, Ni, Al, Mg, Zr, Ti, etc.), and lithium-titanium oxides represented by the general formula Li₄Ti₅O₁₂ (including complex oxides in which a part of the constituent elements is substituted by an element such as Co, Ni, Al, Mg, Zr, Ti, etc.)]; lithium-containing complex oxides of layer structure [e.g., lithium cobalt oxides represented by the general formula LiCoO₂ (including complex oxides in which a part of the constituent elements is substituted by an element such as Ni, Mn, Al, Mg, Zr, Ti, etc.), and lithium nickel oxides represented by the general formula LiNiO₂ (including complex oxides in which a part of the constituent elements is substituted by a substituent element containing at least one element selected from Co, Mn, Al, Mg, Zr and Ti)]; and lithium complex compounds of olivine structure represented by the general formula LiM¹PO₄ (where M¹ is at least one selected from Ni, Co, Fe and Mn).

Particularly, the following can be used more preferably because of their high stability under high temperature: the lithium manganese oxides of spinel structure; lithium nickel cobalt complex oxides represented by the general formula LiNi_{1-x-y}CoₓM²_{y}O₂, in which a part of Ni in the lithium nickel oxide of layer structure is substituted by Co and an element M² (where M² is a substituent element containing at least one element selected from Mn, Al, Mg, Zr and Ti, and x and y preferably satisfy the relations: 0.05≦x≦0.4, 0≦y≦0.5, and more preferably satisfy the relations: 0.1≦x≦0.4, 0.02≦y≦0.5); and the lithium complex compounds of olivine structure. Specific examples of the lithium manganese oxides of spinel structure include such compositions as Li₁₊ₓMn_{2-x-y}M³_{y}O₄ (where M³ is a substituent element containing at least one element selected from Co, Ni, Al, Mg, Zr and Ti, and x and y satisfy the relations: −0.05≦x≦0.1 and 0≦y≦0.3) and Li₁₊ₓMn_{1.5}Ni_{0.5}O₄ (−0.05≦x≦0.1). Further, specific examples of the lithium nickel cobalt oxides of layer structure include such compositions as Li₁₊ₓN_{1/3}Co_{1/3}Mn_{1/3}O₂ (−0.05≦x≦0.1) and Li₁₊ₓNi_{0.7}Co_{0.25}Al_{0.05}O₂ (−0.05≦x≦0.1).

Further, for allowing a battery to correspond to the large current charge/discharge more satisfactorily, it is desirable that the battery contains the lithium cobalt oxide of layer structure (more preferably, a complex oxide in which a part of the constituent elements is substituted by an element such as Ni, Mn, Al, Mg, Zr, Ti, etc.) or the lithium nickel oxide of layer structure (more preferably, a lithium nickel cobalt complex oxide) as a positive electrode active material, and a ratio thereof is in a range of 50 to 80 mass % based on the total amount of the positive electrode active material. As for other active materials, it is desirable that the battery contains the lithium manganese oxide of spinel structure.

The above-described conductive assistant may be added on an as needed basis for the purpose of improving the conductivity or the like of the positive electrode mixture layer. Examples of the conductive powder serving as a conductive assistant include carbon powders such as carbon black, ketjen black, acetylene black, fibrous carbon and graphite as well as metallic powder such as nickel powder.

Examples of the above-described binder include but are not limited to polyvinylidene fluoride and polytetrafluoroethylene.

In the battery of the present invention, a preferable range of a ratio p/n (where p represents a mass of the positive electrode active material and n represents a mass of the negative electrode active material) varies depending on the kind of the active electrode active material. For example, when the positive electrode active material mainly contains the lithium cobalt oxide of layer structure, it is desirable that the ratio p/n is in a range of 2.05 to 2.30 in a face where the positive electrode mixture layer and the negative electrode mixture layer are opposed to each other. Further, when the positive electrode active material mainly contains the lithium nickel oxide of layer structure, it is desirable that the ratio p/n is in a range of 1.69 to 1.90 in the face where the positive electrode mixture layer and the negative electrode mixture layer are opposed to each other.

Further, in the battery of the present invention, it is desirable that a ratio PC/NC (where PC represents an electric capacity of the positive electrode active material per 1 g and NC represents an electric capacity of the negative electrode active material per 1 g) is in a range of 0.97 to 1.10 in the face where the positive electrode mixture layer and the negative electrode mixture layer are opposed to each other. Since the ratio p/n and the ratio PC/NC are set in the above-described ranges, it is possible to optimize the ratio of the electric capacity between the positive electrode and the negative electrode, and hence charge-discharge cycle characteristics are increased further.

The electric capacity PC of the positive electrode active material per 1 g is calculated as follows. First, a model cell which is a counter electrode of a lithium foil is produced. Then, the positive electrode is charged (constant current charge) up to 4.3 V at a current value of 0.25 mA/cm² per unit area, charged continuously at a constant voltage of 4.3 V until the current value decreases to 0.025 mA/cm², and then discharged to 3 V at the current value of 0.25 mA/cm² per unit area. A discharge capacity of the positive electrode active material per 1 g is obtained on the basis of the discharge capacity measured at this time, which is defined as the electric capacity PC described above.

Further, the electric capacity NC of the negative electrode active material per 1 g is calculated as follows. First, a model cell which is a counter electrode of a lithium foil is produced. Then, the negative electrode is charged (constant current charge) up to 0.010 V at the current value of 0.25 mA/cm² per unit area, charged continuously at a constant voltage of 0.010 V until the current value decreases to 0.025 mA/cm², and then discharged to 1.5 V at the current value of 0.25 mA/cm² per unit area. A discharge capacity of the negative electrode active material per 1 g is obtained based on the discharge capacity measured at this time, which is defined as the electric capacity NC described above.

A porous film in which a plurality of thermoplastic resin membranes each containing thermoplastic resin having a different melting point are laminated, or a porous film in which a thermoplastic resin membrane and a porous membrane that is composed mainly of inorganic particles are laminated is disposed as a separator between the negative electrode and the positive electrode.

Generally, a single porous film made of polyolefin used for the lithium-ion secondary battery contains resin having a melting point in the vicinity of a shutdown temperature, so as to cause shutdown in the vicinity of 135° C. while keeping heat resistance to some extent. However, due to a large distortion of the film, when the battery is used in an electric tool or the like, the film tends to shrink or clog owing to the heat generation in the battery before causing the shutdown, which may result in short circuits or characteristic degradation. Further, when the melting point of the resin is set high in consideration of heat resistance, the shutdown is less likely to occur, which causes safety problems.

On the other hand, the laminate used as a separator in the present invention contains not only a porous layer (low-melting-point resin layer) containing resin having a melting point of 120 to 140° C. at which the shutdown is caused, but also a porous layer (high-melting-point resin layer) containing resin having a melting point of 150° C. or higher or a porous layer (heat-resistant inorganic particle layer) composed mainly of inorganic particles having a heat resistant temperature of 150° C. or higher. Therefore, even in the case where the battery is used for the application purpose such as electric tools where the internal temperature of the battery tends to increase, the heat shrinkage of the separator is suppressed and the clogging is less likely to occur, whereby the characteristics of the separator are maintained stably. Because of this, the characteristics of the negative electrode active material and the positive electrode active material are exhibited effectively, and therefore, a battery that is less likely to cause characteristic degradation by the large current charge/discharge and has high reliability even under relatively high temperature environment can be obtained. The separator may be a two-layered laminate composed of a high-melting-point resin layer or heat-resistant inorganic particle layer and a low-melting-point resin layer, but the following are used particularly preferably in view of the above-described object: a three or more layered laminate in which the high-melting-point resin layers are disposed on both surfaces and the low-melting-point resin layer is disposed therebetween, a three or more layered laminate composed of the high-melting-point resin layer, the heat-resistant inorganic particle layer and the low-melting-point resin layer.

The melting point of the resin contained in each layer of the separator as used herein refers to a melting temperature measured by a differential scanning calorimeter (DSC) according to the regulations of Japanese Industrial Standards (JIS) K 7121.

In the low-melting-point resin layer, a porous film formed of resin such as polyethylene, polybutene, and ethylene-propylene copolymer (low-melting-point resin melting at 120 to 140° C.) is used. Particularly, high-density polyethylene having a density of 0.94 to 0.97 g/cm³ is preferable as low-melting-point resin. The low-melting-point resin layer may contain components other than the above-described low-melting-point resin. Examples of such components include resin having a melting point other than 120 to 140° C. (for example, high-melting-point resin described later) and inorganic particles contained in a heat-resistant inorganic particle layer described later. The content of the low-melting-point resin (melting at 120 to 140° C.) in the low-melting-point resin layer preferably is 80 to 100 mass % based on the total amount of the low-melting-point resin layer.

Further, in the high-melting-point resin layer, a porous film formed of resin such as polypropylene, poly4-methylpentene-1, and poly3-methylbutene-1 (high-melting-point resin melting at 150° C. or higher) is used. Particularly, polypropylene is preferable as high-melting-point resin. The high-melting-point resin layer may contain components other than the above-described high-melting-point resin. Examples of such components include resin having a melting point less than 150° C. (for example, low-melting-point resin described above) and inorganic particles contained in the heat-resistant inorganic particle layer described later. The content of the high-melting-point resin (melting at 150° C. or higher) in the high-melting-point resin layer preferably is 80 to 100 mass % based on the total amount of the high-melting-point resin layer.

As the above-described porous film in which the plurality of thermoplastic resin membranes each containing thermoplastic resin having a different melting point are laminated, it is possible to use a commercial laminate film produced by a method in which a porous layer containing resin melting at 120 to 140° C. that is formed by a drawing method, extraction method or the like and a porous layer containing resin melting at 150° C. or higher that is formed by the drawing method, extraction method or the like are superposed and laminated together by drawing, crimping, adhesive or the like, or a commercial laminate film produced by a method in which a layer containing resin melting at 120 to 140° C. and a layer containing resin melting at 150° C. or higher are crimped thermally, and subjected to the drawing or the like so as to increase porosity.

Further, as the inorganic particles forming the heat-resistant inorganic particle layer, it is preferable to use inorganic particles having a heat resistant temperature of 150° C. or higher, i.e., having heat resistance free from deformation owing to softening or the like at least at 150° C., having electrical insulation properties, and having electrochemical stability (less susceptible to oxidation-reduction in the operating voltage range of the battery). Specific examples of the inorganic particles include inorganic oxides such as an iron oxide, SiO₂, Al₂O₃, TiO₂, BaTiO₃, and ZrO₂; inorganic nitrides such as an aluminum nitride and a silicon nitride; hardly-soluble electrovalent compounds such as a calcium fluoride, a barium fluoride, and barium sulfate; covalent compounds such as silicon and diamond; and clays such as montmorillonite. Here, the above-described inorganic oxides may be materials derived from the mineral resources such as boehmite, zeolite, apatite, kaoline, mullite, spinel, olivine, and mica or artificial products of these materials. Among the above-described inorganic oxides, Al₂O₃, SiO₂, and boehmite are particularly preferable.

The shape of the inorganic particle may be nearly spherical or plate-like, and plate-like particles are preferable for avoiding short circuits. Typical examples of the plate-like particles include plate-like Al₂O₃ and plate-like boehmite. It also is suitable to use inorganic particles having a secondary particle structure in which the secondary particle is formed by the agglomeration of primary particles. By using the particles having the secondary particle structure, cohesion between the particles is avoided to some extent, and hence the spacing between the particles is secured appropriately. Thus, a path for ion permeation is secured and high ionic permeability is maintained, whereby a configuration suitable for the large current charge/discharge is obtained.

The average particle size of the inorganic particles preferably is 0.01 μm or more, more preferably is 0.1 μm or more; and preferably is 15 μm or less, more preferably is 5 μm or less. The average particle size used herein may be defined as a number average particle size that is measured using a laser diffraction particle size analyzer (e.g., “LA-920” manufactured by HORIBA, Ltd.) by dispersing these particles in a medium (e.g., water) that does not dissolve the particles.

The heat resistant inorganic particle layer is a porous layer formed by binding the respective inorganic particles using a binder or the resin used in the high-melting-point resin layer, and is formed on the low-melting-point resin layer or the high-melting-point resin layer. Regarding the ratio of the inorganic particles in the heat resistant inorganic particle layer, a solid content of the inorganic particles should be 50 vol % or more so that layer is composed mainly of the inorganic particles. Further, in order to obtain favorable binding properties by the binder or the like, the solid content of the inorganic particle preferably is 99 vol % or less.

Examples of the above-described binder include carboxymethyl cellulose, hydroxyethyl cellulose, polyvinyl alcohol, polyvinyl butyral, polyvinyl pyrrolidone, cross-linked acrylic resin, polyurethane, epoxy resin as well as highly flexible resins such as ethylene-vinyl acetate copolymer, ethylene-acrylic acid copolymer, fluoro-rubber, and styrene-butadiene rubber. It is particularly preferable to use a heat-resistant binder capable of maintaining excellent binding property until 150° C. or higher while keeping the shape of the heat resistant inorganic particle layer. The heat resistant inorganic particle layer can be formed by dispersing the inorganic particles, the binder and the like in a solvent so as to obtain a slurry, applying the slurry thus obtained on the high-melting-point resin layer or the low-melting-point resin layer, and drying the coating.

The thickness of the high-melting-point resin layer or the heat resistant inorganic particle layer preferably is 1 μm or more, and more preferably is 3 μm or more for suppressing the heat shrinkage of the separator; whereas, the thickness thereof preferably is 15 μm or less, and more preferably is 10 μm or less for thinning the overall thickness of the separator. Further, the thickness of the low-melting-point resin layer preferably is 3 μm or more, and more preferably is 5 μm or more for causing the shutdown reliably; whereas, the thickness thereof preferably is 20 μm or less, and more preferably is 15 μm or less for thinning the overall thickness of the separator.

The non-aqueous electrolyte according to the battery of the present invention is not particularly limited, and a general-purpose non-aqueous electrolyte in which an electrolyte salt (e.g., lithium salt) is dissolved in a non-aqueous solvent (e.g., organic solvent) is used generally.

Examples of the non-aqueous solvent include dimethyl carbonate, diethyl carbonate, methyl ethyl carbonate, methyl propionate, ethylene carbonate, propylene carbonate, butylene carbonate, γ-butyrolactone, ethylene glycol sulfite, 1,2-dimethoxyethane, 1,3-dioxolane, tetrahydrofuran, 2-methyl-tetrahydrofuran, diethyl ether. The non-aqueous solvent may include two or more of these materials.

Examples of the electrolyte salt include LiClO₄, LiPF₆, LiBF₄, LiAsF₆, LiSbF₆, LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃ (2≦n≦5), and LiN(RfOSO₂)₂ (where Rf represents a fluoroalkyl group). The concentration of the electrolyte salt in the electrolyte preferably is 0.3 to 1.7 mol/L, and more preferably is 0.5 to 1.5 mol/L.

For further improvement of the charge-discharge cycle characteristics, storage characteristics or the like, the non-aqueous electrolyte may contain additives such as vinylene carbonate and derivative thereof; alkylbenzene such as cyclohexylbenzene and tertiary butylbenzene; cyclic sultone such as biphenyl and propane sultone; sulfide such as diphenyl disulfide. The amount of the additive in the non-aqueous electrolyte preferably is 0.1 to 10 mass %, and more preferably is 0.5 to 5 mass %.

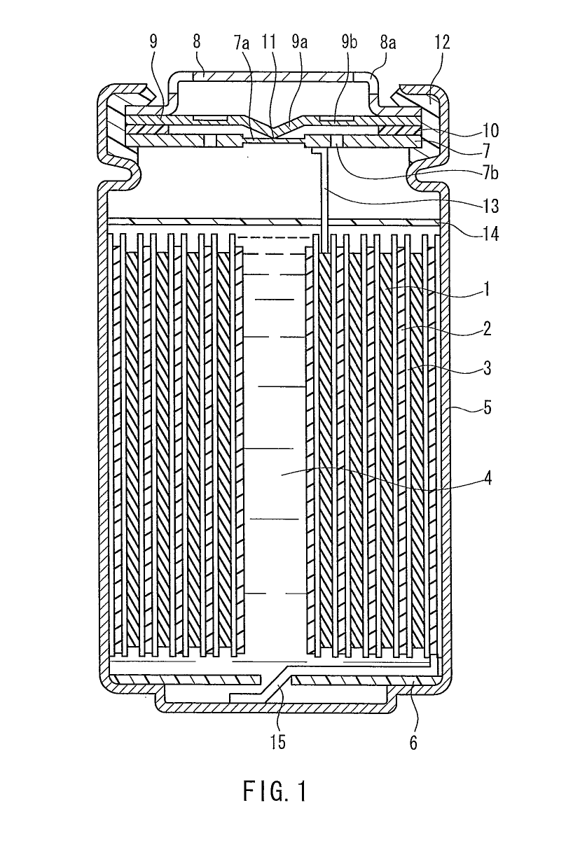

Next, an example of a lithium-ion secondary battery according to the present invention will be described based on the drawing. FIG. 1 is a cross-sectional view showing the exemplary lithium-ion secondary battery of the present invention. In FIG. 1, the lithium-ion secondary battery includes a positive electrode 1 that has a positive electrode mixture layer containing a positive electrode active material of the present invention described above, a negative electrode 2 that has a negative electrode mixture layer containing a negative electrode active material, a separator 3, and a non-aqueous electrolyte 4. The positive electrode 1 and the negative electrode 2 are wound spirally, with the separator 3 interposed therebetween. Then, the obtained spiral-structured electrode body is housed into a cylindrical battery can 5 together with the non-aqueous electrolyte 4.

Note here that, for avoiding complication, FIG. 1 does not show a metal foil (current collector) and the like that were used for producing the positive electrode 1 and the negative electrode 2. Further, although the separator 3 is illustrated cross-sectionally, the cross section is not hatched.

The battery can 5 is made of, e.g., iron, and a surface thereof is plated with nickel. Before the insertion of the spiral-structured electrode body, an insulator 6 made of, e.g., polypropylene is disposed on a bottom portion of the battery can 5. A sealing plate 7 is made of, e.g., aluminum and has a disc shape. A central portion of the sealing plate 7 has a thin portion 7a, and the vicinity of the thin portion 7a is provided with a pressure inlet 7b, which is a hole for allowing a battery internal pressure to act on an explosion-protection valve 9. A protruded portion 9a of the explosion-protection valve 9 is welded to an upper face of the thin portion 7a, whereby a weld 11 is formed. For easier understanding of FIG. 1, the thin portion 7a formed on the sealing plate 7, the protruded portion 9a of the explosion-protection valve 9 and the like are illustrated only cross-sectionally, and outlines thereof behind the cross sections are omitted. Further, for easier understanding of the drawing, the weld 11 between the thin portion 7a of the sealing plate 7 and the protruded portion 9a of the explosion-protection valve 9 are illustrated exaggeratingly as compared with the actual states.

A terminal plate 8 is made of, e.g., rolled steel, a surface thereof is plated with nickel, and a circumferential end portion thereof has a flanged, calotte shape. Further, the terminal plate 8 is provided with a gas outlet 8a. The explosion-protection valve 9 is made of, e.g., aluminum and has a disc shape, and a central portion thereof has the protruded portion 9a with a tip on a power generating element side (lower side in FIG. 1) and a thin portion 9b. A lower face of the protruded portion 9a is welded to the upper face of the thin portion 7a of the sealing plate 7, whereby the weld 11 is formed. An insulating packing 10 is made of, e.g., polypropylene, has a ring shape, and is disposed between the upper side of a circumferential end portion of the sealing plate 7 and the lower side of the explosion-protection valve 9. The insulating packing 10 insulates the sealing plate 7 and the explosion-protection valve 9, and seals a space therebetween for avoiding leakage of the electrolyte. A ring-shaped gasket 12 is made of, e.g., polypropylene. A lead 13 is made of, e.g., aluminum, and connects the sealing plate 7 and the positive electrode 1. An insulator 14 is disposed above the spiral-structured electrode body, and the negative electrode 2 and the bottom portion of the battery can 5 are connected by a lead 15 made of, e.g., nickel.

In the battery of FIG. 1, the thin portion 7a of the sealing plate 7 and the protruded portion 9a of the explosion-protection valve 9 are in contact with each other at the weld 11, a circumferential end portion of the explosion-protection valve 9 and the circumferential end portion of the terminal plate 8 are in contact with each other, and the positive electrode 1 and the sealing plate 7 are connected by the lead 13 on a positive electrode side. Thereby, in a normal state, the positive electrode 1 and the terminal plate 8 are connected electrically with each other by the lead 13, the sealing plate 7, the explosion-protection valve 9, and the weld 11 thereof, thereby functioning normally as an electric circuit.

In the case where the battery is put in abnormal circumstances, such as exposure under high temperature or heat generation due to overcharge, and if the gas generated inside the battery increases the internal pressure of the battery, the increased internal pressure deforms the central portion of the explosion-protection valve 9 in an internal pressure direction (upward direction in FIG. 1). Accordingly, a shearing force acts on the thin portion 7a of the sealing plate 7 integrated therewith via the weld 11, thereby breaking the thin portion 7a of the sealing plate 7 or separating the weld 11 between the thin portion 7a of the sealing plate 7 and the protruded portion 9a of the explosion-protection valve 9. The battery of the present invention is designed so that, after this breakage or separation, the thin portion 9b provided on the explosion-protection valve 9 is cleaved so as to discharge the gas from the gas outlet 8a of the terminal plate 8 to the outside of the battery, whereby explosion of the battery can be avoided.

The lithium-ion secondary battery of the present invention is less likely to cause characteristic degradation due to charge/discharge at large current, maintains characteristics stably for a long period, and has high reliability even under relatively high temperature environment. Therefore, the lithium-ion secondary battery of the present invention is suitable for the application purpose, such as use as a power source of electric tools, where charge and discharge are repeated at large current and the battery is used under relatively high temperature environment. Further, the lithium-ion secondary battery of the present invention also can be used for various application purposes for which conventional lithium-ion secondary batteries have been used.

### EXAMPLES

Hereinafter, the present invention will be described in detail based on examples. However, the following examples do not limit the present invention.

### Example 1

Graphite powder having an R value of Raman spectrum of 0.32 when excited by an argon laser with a wavelength of 514.5 nm, an interplanar spacing d₀₀₂ between 002 lattice planes of 0.336 nm, and a BET specific surface area of 3.3 m²/g was used as a negative electrode active material. Carboxymethyl cellulose and styrene-butadiene copolymer rubber were used as binders. Water was used as a solvent. By mixing the negative electrode active material, the binders, and the solvent at a mass ratio of 98:1:1, a slurry negative electrode mixture-containing paste was prepared. The negative electrode mixture-containing paste thus obtained was applied to both faces of a negative electrode current collector made of a copper foil having a thickness of 10 μm, and dried so as to form a negative electrode mixture layer. Then, the layer was press-formed using a roller until the density of the layer became 1.54 g/cm³, and cut so as to form a negative electrode having a width of 57 mm and a length of 1025 mm.

A positive electrode mixture-containing paste was prepared by mixing 66.5 parts by mass of LiNi_{0.82}Co_{0.10}Al_{0.03}O₂ and 28.5 parts by mass of LiMn₂O₄ as positive electrode active materials; 2.5 parts by mass of acetylene black as a conductive assistant; and 2.5 parts by mass of polyvinylidene fluoride as a binder uniformly by using N-methyl-2-pyrolidone as a solvent. The paste thus obtained was applied to both faces of a positive electrode current collector made of an aluminum foil having a thickness of 15 μm, and dried so as to form a positive electrode mixture layer. Then, the layer was press-formed using a roller until the thickness of the layer became 84 μm, and cut so as to form a positive electrode having a width of 55 mm and a length of 886 mm.

A porous laminate film in which a polypropylene film having a thickness of about 7 μm (high-melting-point resin layer, melting point of the polypropylene: 165° C.), a polyethylene film having a thickness of about 7 μm (low-melting-point resin layer, melting point of the polyethylene: 125° C.), and a polypropylene film having a thickness of about 7 μm (high-melting-point resin layer, melting point of the polypropylene: 165° C.) were laminated in this order was prepared as a separator. A total thickness of the porous laminate film (separator) was about 20 μm, and an opening ratio thereof was 46%.

Next, the positive electrode and the negative electrode were wound spirally, with the separator interposed therebetween, and then housed into a cylindrical outer can. In the face where the positive electrode mixture layer and the negative electrode mixture layer were opposed to each other, the ratio p/n (where p represents the mass of the positive electrode active material and n represents the mass of the negative electrode active material) was 1.8, and the ratio PC/NC (where PC represents the electric capacity of the positive electrode active material per 1 g and NC represents the electric capacity of the negative electrode active material per 1 g) was 1.01.

A non-aqueous electrolyte was prepared by dissolving LiPF₆ in a ratio of 1.2 mol/L in a solvent in which ethylene carbonate and dimethyl carbonate were mixed in a volume ratio of 1:2, and further adding 2 mass % of vinylene carbonate. After injection of the non-aqueous electrolyte thus obtained into the outer can, the can was sealed, whereby a cylindrical lithium-ion secondary battery having a diameter of 18 mm and a height of 65 mm was produced.

### Example 2

A lithium-ion secondary battery of Example 2 was produced in the same manner as in Example 1, except that the density of the negative electrode mixture layer was 1.60 g/cm³, the ratio p/n was 1.86 by adjusting the thicknesses of the positive electrode mixture layer and the negative electrode mixture layer, and the ratio PC/NC was 1.04.

### Example 3

A lithium-ion secondary battery of Example 3 was produced in the same manner as in Example 1, except that a mixture composed of 80 mass % of graphite powder having the R value of Raman spectrum of 0.32 when excited by the argon laser with the wavelength of 514.5 nm, having the interplanar spacing d₀₀₂ between the 002 lattice planes of 0.336 nm, and having the BET specific surface area of 3.3 m²/g, and 20 mass % of graphite powder having the R value of 0.08 was used instead as a negative electrode active material; and the same quantity of ketjen black was used in place of acetylene black as a conductive assistant of the positive electrode.

### Example 4

A lithium-ion secondary battery of Example 4 was produced in the same manner as in Example 1, except that the same quantity of LiCoO₂ was used in place of LiNi_{0.82}Co_{0.10}Al_{0.03}O₂ as a positive electrode active material, and the same quantity of ketjen black was used in place of acetylene black as a conductive assistant of the positive electrode. The ratio p/n of the battery was 2.18, and the ratio PC/NC was 1.01.

### Example 5

A slurry for forming a heat resistant inorganic particle layer was prepared by dispersing 1 kg of boehmite secondary particles (average particle size: 2 μm) into 1 kg of water, and further dispersing 120 g of styrene-butadiene rubber latex (solid content: 40 mass %) thereto uniformly. The slurry thus obtained was applied to one face of a microporous membrane made of polyethylene melting at 135° C. (low-melting-point resin layer, thickness: 16 μm, porosity: 45%) and dried so as to form a laminate composed of a heat resistant inorganic particle layer having a thickness of 5 μm and a low-melting-point resin layer having a thickness of 16 μm. A lithium-ion secondary battery of Example 5 was produced in the same manner as in Example 1, except that this laminate was used as a separator.

### Comparative Example 1

A lithium-ion secondary battery of Comparative Example 1 was produced in the same manner as in Example 1, except that graphite powder having the R value of 0.12 was used singly as a negative electrode active material. The ratio p/n of the battery was 1.8, and the ratio PC/NC was 1.01.

### Comparative Example 2

A lithium-ion secondary battery of Comparative Example 2 was produced in the same manner as in Example 1, except that a single-layered porous film made of polyethylene having a thickness of 25 μm and an opening ratio of 42% was used as a separator.

### Comparative Example 3

A lithium-ion secondary battery of Comparative Example 3 was produced in the same manner as in Example 1, except that the density of the negative electrode mixture layer was 1.68 g/cm³, the ratio p/n was 1.8 by adjusting the thicknesses of the positive electrode mixture layer and the negative electrode mixture layer, and the ratio PC/NC was 1.01.

### Comparative Example 4

A lithium-ion secondary battery of Comparative Example 4 was produced in the same manner as in Example 1, except that the density of the negative electrode mixture layer was 1.35 g/cm³, the ratio p/n was 1.8 by adjusting the thicknesses of the positive electrode mixture layer and the negative electrode mixture layer, and the ratio PC/NC was 0.99.

### Comparative Example 5

A lithium-ion secondary battery of Comparative Example 5 was produced in the same manner as in Example 1, except that a porous laminate film in which a polypropylene film having a thickness of about 7 μm (high-melting-point resin layer, melting point of the polypropylene: 165° C.), a polyethylene film having a thickness of about 7 μm (melting point of the polyethylene: 105° C.) and a polypropylene film having a thickness of about 7 μm (high-melting-point resin layer, melting point of the polypropylene: 165° C.) were laminated in this order was used as a separator.

Next, a constant-current and constant-voltage charge (total charge time: 2.5 h) was performed with respect to the lithium-ion secondary batteries of Examples 1-5 and Comparative Examples 1-5 at a constant current of 0.75 A and a constant voltage of 4.2 V. Then, each battery was discharged (end-of-discharge voltage: 2.5 V) at a constant current of 1.5 A for measuring an initial discharge capacity. Next, after the constant-current and constant-voltage charge, each battery was discharged (end-of-discharge voltage: 2.0 V) at a constant current of 25 A (discharge rate: about 16 C) for measuring a large-current discharge capacity. A ratio of the large-current discharge capacity with respect to the initial discharge capacity was evaluated as a large current characteristic. Further, each battery was charged and discharged in the same condition as in the measurement of the initial discharge capacity, and a ratio of the discharge capacity at this time with respect to the initial discharge capacity was evaluated as a capacity recovery rate. The results are shown in Table 1.

TABLE 1

| | Initial | Large | Capacity |
|---|---|---|---|
| | discharge | current | recovery |
| | capacity | characteristic | rate |
| | (mAh) | (%) | (%) |
| Ex. 1 | 1550 | 97 | 97 |
| Ex. 2 | 1586 | 96 | 97 |
| Ex. 3 | 1558 | 96 | 97 |
| Ex. 4 | 1450 | 97 | 96 |
| Ex. 5 | 1545 | 97 | 97 |
| Comp. Ex. 1 | 1560 | 82 | 96 |
| Comp. Ex. 2 | 1552 | 96 | 96 |
| Comp. Ex. 3 | 1545 | 93 | 97 |
| Comp. Ex. 4 | 1490 | 94 | 96 |
| Comp. Ex. 5 | 1550 | 95 | 45 |

Further, by repeating charge-discharge cycles at large current, ratios of discharge capacities at 100th, 200th and 500th cycles with respect to the discharge capacity at the first cycle were measured so as to evaluate charge-discharge cycle characteristics. The results are shown in Table 2. The condition at the time of evaluating the charge-discharge cycle characteristics was that each battery was charged at a constant current of 4 A and a constant voltage of 4.2 V, i.e., the constant-current and constant-voltage charge, and discharged at a constant current of 3 A (end-of-discharge voltage: 2.0 V).

TABLE 2

| | charge-discharge cycle | | |
|---|---|---|---|
| | characteristics (%) | | |
| | 100th cycle | 200th cycle | 500th cycle |
| Ex. 1 | 96 | 89 | 73 |
| Ex. 2 | 96 | 88 | 72 |
| Ex. 3 | 96 | 89 | 73 |
| Ex. 4 | 96 | 90 | 74 |
| Ex. 5 | 96 | 89 | 74 |
| Comp. Ex. 1 | 94 | 85 | 69 |
| Comp. Ex. 2 | 93 | 84 | 68 |
| Comp. Ex. 3 | 85 | 73 | 66 |
| Comp. Ex. 4 | 85 | 72 | 67 |
| Comp. Ex. 5 | 88 | 74 | 66 |

Further, a heat resistance test was performed by using same separators as those used for the lithium-ion secondary batteries of Examples 1 and 5, and Comparative Examples 2 and 5. Each separator was cut in 40 mm wide and 60 mm long, sandwiched by glass plates from both sides, and left in a thermostat at 130° C. for an hour. After the test, each separator was taken out from the thermostat for measuring a change amount of the length in a width direction and a change amount of a Gurley value.

The Gurley value is an indicator of an air permeability of a membrane evaluated by a method according to JIS P 8117, and is expressed as seconds in which 100 ml air passes through the membrane under a pressure of 0.879 g/mm².

Next, a ratio of the change amount of the length in the width direction thus obtained with respect to the length before the test was evaluated as a shrinkage ratio. Assuming that the Gurley value before the test was 100, a relative value of the Gurley value after the test also was evaluated. The results are shown in Table 3.

TABLE 3

| | Shrinkage | Gurley value |
|---|---|---|
| | ratio (%) | (relative value) |
| Ex. 1 | 0.6 | 102 |
| Ex. 5 | 1.0 | 101 |
| Comp. Ex. 2 | 7.2 | 123 |
| Comp. Ex. 5 | 0.6 | 118 |

Since the lithium-ion secondary batteries of Examples 1-5 have a configuration in which the reaction at the electrodes is uniformized and which corresponds to the temperature increase inside the battery owing to charge/discharge, they were able to have: superior large current characteristics (Table 1); less characteristic degradation even after the discharge exceeding 10 C (Table 1); favorable charge-discharge cycle characteristics (Table 2); and excellent reliability (Table 3)

On the other hand, in the battery of Comparative Example 1, since the R value of the negative electrode active material was small, smooth insertion/desorption of lithium ions on the particle surfaces was prevented, and hence the battery was unable to correspond to the large current charge/discharge. Accordingly, the large current characteristic of the battery was decreased. Further, in the battery of Comparative Example 2 using the single-layered porous film as a separator, as indicated by the increased Gurley value at high temperature, the separator was gradually clogged, which decreased the charge-discharge cycle characteristics. Further, the risk of short circuits owing to the heat shrinkage of the separator decreased reliability. In the batteries of Comparative Examples 3 and 4, since the density of the negative electrode mixture layer was inappropriate, the reaction inside the negative electrode mixture layer during the charge/discharge was not uniformized, which decreased the charge-discharge cycle characteristics. Moreover, in the battery of Comparative Example 5, although the separator did not shrink, excessively low melting point of the resin contained in the low-melting-point resin layer changed the characteristics of the separator when the discharge exceeding 10 C was performed, which resulted in the degradation of the discharge capacity.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes that come within the meaning and range of equivalency of the claims are intended to be embraced therein.

### INDUSTRIAL APPLICABILITY

According to the present invention, it is possible to provide a lithium-ion secondary battery that has superior reliability and charge-discharge cycle life at large current and that is suitable for the application purpose such as electric tools where charge and discharge are repeated at large current.

### DESCRIPTION OF REFERENCE NUMERALS

1 positive electrode
2 negative electrode
3 separator
4 non-aqueous electrolyte
5 battery can

1. A lithium-ion secondary battery, comprising:
a negative electrode having a negative electrode mixture layer containing a negative electrode active material;
a positive electrode having a positive electrode mixture layer containing a positive electrode active material;
a separator; and
a non-aqueous electrolyte,
wherein the negative electrode active material contains a carbon material having an R value of Raman spectrum of 0.2 to 0.8 when excited by an argon laser with a wavelength of 514.5 nm and having an interplanar spacing d₀₀₂ between 002 lattice planes of 0.340 nm or less,
a ratio of the carbon material is 60 mass % or more based on the total amount of the negative electrode active material,
a density of the negative electrode mixture layer is 1.40 g/cm³ to 1.65 g/cm³, and
the separator is formed from a laminate composed of a porous layer containing resin having a melting point of 120° C. to 140° C., and a porous layer containing resin having a melting point of 150° C. or higher or a porous layer composed mainly of inorganic particles having a heat resistant temperature of 150° C. or higher.

2. The lithium-ion secondary battery according to claim 1, wherein a BET specific surface area of the negative electrode active material is 1.5 m²/g to 4.5 m²/g.

3. The lithium-ion secondary battery according to claim 1, wherein the positive electrode active material contains at least one compound selected from the group consisting of a lithium manganese oxide of spinel structure, a lithium nickel cobalt complex oxide of layer structure, and a lithium complex compound of olivine structure.

4. The lithium-ion secondary battery according to claim 1,
wherein the positive electrode active material contains a lithium manganese oxide of spinel structure and a lithium nickel cobalt complex oxide of layer structure, and
a ratio of the lithium nickel cobalt complex oxide of layer structure is 50 mass % to 80 mass % based on the total amount of the positive electrode active material.

5. The lithium-ion secondary battery according to claim 3, wherein, where PC represents an electric capacity of the positive electrode active material per 1 g and NC represents an electric capacity of the negative electrode active material per 1 g, a ratio PC/NC is in a range of 0.97 to 1.10 in a face where the positive electrode mixture layer and the negative electrode mixture layer are opposed to each other.

6. The lithium-ion secondary battery according to claim 4, wherein, where PC represents an electric capacity of the positive electrode active material per 1 g and NC represents an electric capacity of the negative electrode active material per 1 g, a ratio PC/NC is in a range of 0.97 to 1.10 in a face where the positive electrode mixture layer and the negative electrode mixture layer are opposed to each other.
